(19) United States
(12) Patent Application Publication
(10) Pub. No.: US 2012/0204693 A1
(43) Pub. Date: Aug. 16, 2012

(54) RECORDING MEDIUM CUTTING APPARATUS

(75) Inventor: Masahito Yoshida, Shiki-shi (JP)

(73) Assignee: CANON KABUSHIKI KAISHA, Tokyo (JP)

(21) Appl. No.: 13/370,662

(22) Filed: Feb. 10, 2012

(30) Foreign Application Priority Data
Feb. 14, 2011 (JP) 2011-028822

(51) Int. Cl. B65H 35/00; B26D 7/00

(52) U.S. Cl. 83/105; 83/102; 83/107

(57) ABSTRACT

A recording medium cutting apparatus includes a conveyance unit configured to convey a recording medium, a conveyance path through which the recording medium to be conveyed by the conveyance unit passes, a cutting unit configured to cut the recording medium, a discharge port provided on the midway of the conveyance path, for discharging a portion cut off the recording medium by the cutting unit from the conveyance path, and a discharge unit configured, when the recording medium is cut, to come into contact with the recording medium from an opposite side to the discharge port, to cause a portion to be cut off of the recording medium to be positioned toward an outside of a conveyance path from the discharge port.

### BACKGROUND OF THE INVENTION

1. Field of the Invention

The present invention relates to a recording medium cutting apparatus that cuts off unwanted portions of a recording medium, to obtain single-leaf products of a target size from the recording medium.

2. Description of the Related Art

Conventionally, in image forming apparatus that can obtain single-leaf sheet-like image product, the apparatus can be broadly divided into one that forms an image on a medium of a target size of the product, and one that forms an image on a medium larger than the target size, and subsequently cut unwanted portion to attain the target size.

The apparatus that performs cutting after image formation like the latter includes a large scale apparatus that can obtain a single-leaf product from a roll-like continuous sheet. Such an apparatus has therein a conveyance unit and a cutting unit of a sheet, and separates unwanted portions from the products inside the apparatus.

Separation of the unwanted portions from the products including the cutting unit is generally demanded to respond to various sizes by the identical apparatus.

Japanese Patent Application Laid-Open No. 2007-22070 discusses a cutting unit for cutting trailing edge of a sheet on which an image has been recorded and an unwanted portion separation unit. Japanese Patent Application Laid-Open No. 2007-22070 discusses a method for responding to various purposes such as guiding of a sheet to a cutting and conveyance unit, sandwiching, separation from the conveyance path, by employing a movable type of a paper guide on the upstream downside of a cutter serving as the cutting unit provided in the conveyance path, and by changing a position of the movable paper guide.

With respect to this type of image forming apparatus, as well as mixing of different products with various cutting lengths, performing control for cutting and separation in response to media with various thicknesses or different rigidities also exist as demand issues. Further, even in relation to a layout inside the apparatus, demands for arranging the cutting unit by making the conveyance path other than horizontal or enhancement of processing speeds also have arisen.

In a unit discussed in Japanese Patent Application Laid-Open No. 2007-22070, separation of the unwanted portions after cutting always involves an operation of the paper guide, and since the separation mainly utilizes gravity, an operation time per one cycle which surely enables the separation is liable to become longer.

### SUMMARY OF THE INVENTION

One aspect of the present invention is directed to discarding portions cut off from a recording medium from the conveyance path in a reliable manner and at a high speed.

According to an aspect of the present invention, a recording medium cutting apparatus includes a conveyance unit configured to convey a recording medium, a conveyance path on which the recording medium to be conveyed by the conveyance unit passes, a cutting unit configured to cut the recording medium, a discharge port provided on the midway of the conveyance path, for discharging from the conveyance path a portion cut off from the recording medium by the cutting unit, and a discharge unit configured, when the recording medium is cut, to come into contact with the recording medium from an opposite side to the discharge port, to cause a portion to be cut off from the recording medium to be positioned toward an outside of a conveyance path from the discharge port.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a schematic sectional view of a sheet trailing edge cutting and separation mechanism according to the first exemplary embodiment.

FIG. 2 is a schematic sectional view illustrating an internal configuration of a printer with a built-in sheet cutting and conveying mechanism according to the present invention.

FIG. 3 is a schematic view for explaining an operation of the printer with the built-in sheet cutting and conveying mechanism according to the present invention.

FIG. 4 is a schematic view illustrating a configuration of the cutter included in the sheet cutting and conveying mechanism according to the present invention.

FIG. 5 is a schematic view illustrating a configuration of the sheet cutting and conveyance unit including the sheet trailing edge cutting and separation mechanism according to the present invention.

FIG. 6 illustrates an image formation example on the continuous sheet before cutting corresponding to the sheet cutting and conveying mechanism in FIG. 5.

FIGS. 7A, 7B, 7C, and 7D are schematic views illustrating in a step-by-step manner how the sheet is cut and conveyed by the sheet cutting and conveying mechanism in FIG. 5.

FIGS. 8A, 8B, 8C, and 8D are schematic views illustrating in a step-by-step manner how the sheet is cut and conveyed by the sheet cutting and conveying mechanism in FIG. 5.

FIG. 9 is a block diagram illustrating a control configuration of the sheet cutting and conveying mechanism in FIG. 5.

FIGS. 10A, 10B, and 10C are schematic views illustrating in a step-by-step manner the state of cutting and conveying the sheet by the sheet trailing edge cutting and separation mechanism according to the present invention, when the unwanted portion is short.

FIGS. 11A, 11B, 11C, 11D, and 11E are schematic views illustrating in a step-by-step manner how the sheet is cut and conveyed by the sheet trailing edge cutting and separation mechanism according to the present invention, when the unwanted portion is long.

FIG. 12 is a schematic sectional view of the sheet trailing edge cutting and separation mechanism according to a second exemplary embodiment.

FIG. 13 is a schematic sectional view illustrating a third exemplary embodiment.

### DESCRIPTION OF THE EMBODIMENTS

Various exemplary embodiments, features, and aspects of the invention will be described in detail below with reference to the drawings.

Hereinbelow, exemplary embodiments in a printer using an inkjet method will be described. The printer of the example is a high-speed line printer using a continuous sheet wound into a roll shape and is suitable for printing of a huge amount of sheets in, for example, a print labo.

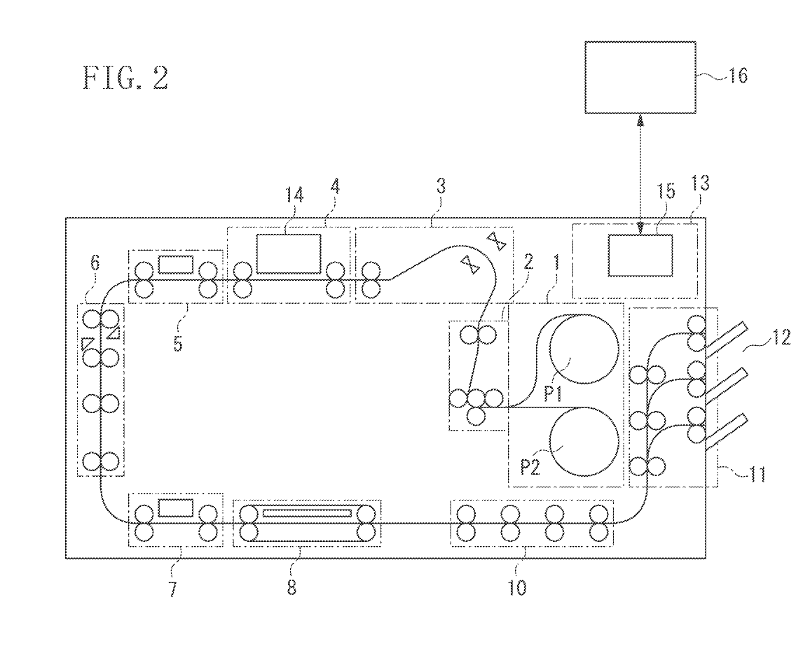

FIG. 2 is a schematic view of a cross-section illustrating an internal configuration of the printer with the built-in sheet trailing edge cutting and separation mechanism according to the present invention.

Inside the printer, there are mainly provided respective units of a sheet supplying unit 1, a decurling unit 2, a skew correction unit 3, a print unit 4, an inspection unit 5, a sheet cutting and conveying unit 6, an information recording unit 7, a drying unit 8, a discharging and conveying unit 10, a sorter unit 11, a discharge tray 12, and a control unit 13. The sheet is conveyed by the conveying mechanism including roller pairs and belts along the sheet conveyance path represented with solid lines in FIG. 2, and is processed by respective units.

The sheet supplying unit 1 accommodates and supplies the continuous sheet wound in a roll shape. The sheet supplying unit 1 is configured to accommodate two rolls P1 and P2, and to alternatively pull out and supply the sheet from either roll. The number of accommodatable rolls is not limited to two, and the sheet supplying unit that accommodates one or three or more rolls may be used.

The decurling unit 2 is a unit that eliminates curl (warpage) of the sheet supplied from the sheet supplying unit 1. In the decurling unit 2, the curl is eliminated by pressing the continuous sheet against circumferential surface of one drive roller using two pinch rollers, and by conveying the sheet while making the sheet to be curved so as to cause the warpage reversely to the curl.

The skew correction unit 3 is a unit that corrects a skew (inclination relative to an original traveling direction) of the sheet which has passed through the decurling unit 2. The skew of the sheet is corrected by pressing a sheet side edge on a reference side against the guide member.

A print unit 4 is a unit that forms an image on the sheet by the print head 14 with respect to the conveyed sheet. The print unit 4 is provided with a plurality of conveyance rollers which conveys the sheet. The print head 14 has a line type print head in which nozzle arrays of the inkjet method are formed within a range that covers a maximum width of the sheets which are assumed to be used.

The print head 14 is configured such that a plurality of print heads is aligned along the conveying direction. Each print head 14 is disposed parallel to one another. The inkjet method can employ a method using heating elements, a method using piezoelectric elements, a method using electrostatic elements, a method using micro-electro-mechanical systems (MEMS) elements or the like. Inks for respective colors each are supplied to the print head 14 via ink tubes from ink tanks.

The inspection unit 5 optically reads out inspection pattern or an image printed on the sheet by the print unit 4, and inspects a state of nozzles of the print heads, a sheet conveyance state, an image position and so forth.

The sheet cutting and conveying unit 6 is equipped with a mechanical cutter that cuts to a predetermined length the sheet after printing. The sheet cutting and conveying unit 6 is also provided with a plurality of conveyance rollers for feeding out the sheet to the next step, and a space for reserving scraps produced by cutting, and includes the sheet trailing edge cutting and separation mechanism according to the present invention.

Print information is recorded on a back surface of the cut sheet, which has been cut for each unit image in the cutter unit 6, by the information recording unit 7, as necessary.

The drying unit 8 heats the sheet printed by the print unit 4, and dries an applied ink in a short time. The drying unit 8 is provided with a heater and also a conveying belt and conveyance rollers for feeding out the sheet to the next step.

The discharging and conveying unit 10 conveys the sheet cut by the sheet cutting and conveying unit 6 and dried by the drying unit 8, and delivers the sheet to the sorter unit 11. The sorter unit 11 sorts the printed sheets for each group as necessary into different trays of the discharge tray 12 and discharges them.

The control unit 13 performs control of the entire printer. The control unit 13 includes a controller 15 equipped with a central processing unit (CPU) 601, a memory, various types of I/O interfaces and a power source. Operation of the printer is controlled based on commands from the controller 15 or an external device 16 such as a host computer connected to the controller 15 via an input/output (I/O) interface.

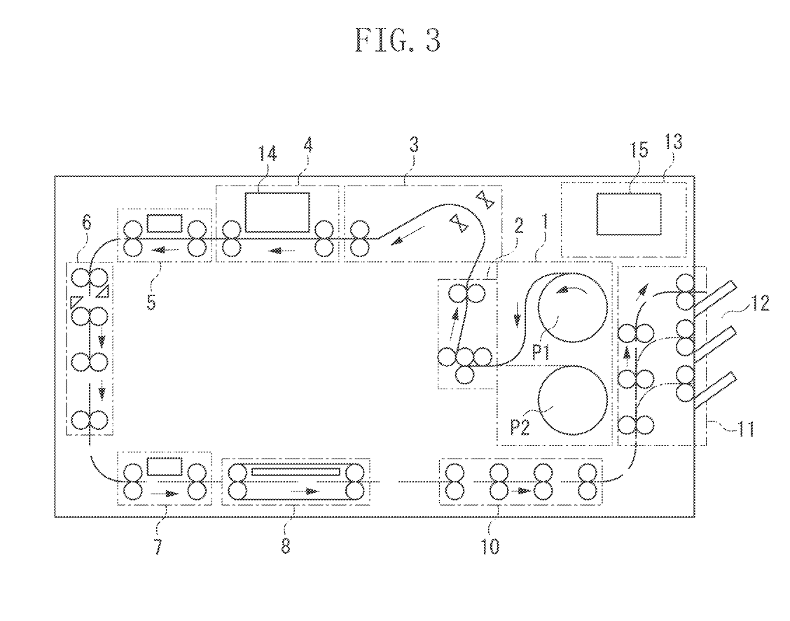

FIG. 3 is a schematic view for explaining an operation of the printer with the built-in sheet trailing edge cutting and separation mechanism according to the present invention.

The conveyance path from printing of the sheet supplied from the sheet supply to discharging into the discharge tray 12 is illustrated with bold lines. The sheet supplied from the sheet supplying unit 1, and processed each by the decurling unit 2, and the skew correction unit 3, is printed on its surface in the print unit 4. The printed sheet is cut to each predetermined unit length set in advance in the sheet cutting and conveying unit 6 via the inspection unit 5. Print information is recorded on the back surface of the cut sheet by the information recording unit 7 as necessary. Then, the cut sheets are conveyed one by one to the drying unit 8 where drying operation is performed. Thereafter, the cut sheets are discharged and stacked on the tray 12 of the sorter unit 11 in sequence via the discharging and conveying unit 10.

The sheet cutting and conveying unit including the sheet trailing edge cutting and separation mechanism according to the present invention, in the printer with the above-described configuration, will be described more in detail.

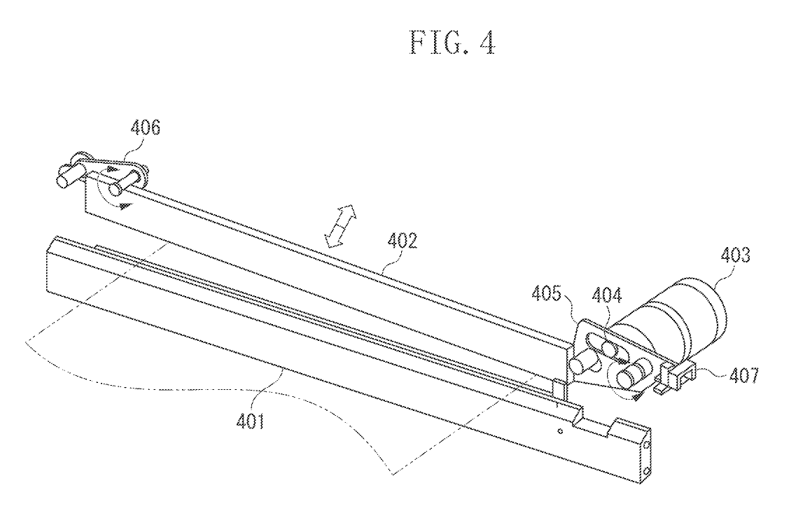

FIG. 4 is a schematic view illustrating a configuration of the cutter included in the sheet cutting and conveying unit. The cutter is generally called a slide type method, and is composed of a fixed blade 401 and a movable blade 402. The movable blade 402 is driven by a cutter motor 403 as a driving source, and moves upwardly and downwardly while obliquely abutting on the fixed blade 401 via a cam 404, a drive-side link 405, and a driven-side link 406. A top dead center at which the movable blade 402 has moved to upside away farthest from the fixed blade 401 is a position to guide the medium between the blades of the cutter during normal conveyance, and a bottom dead center at which the movable blade 402 is lowered to the lowest side is a position at which the medium cutting is surely completed.

A load at the time of cutting fluctuates significantly depending on medium conditions or the like, and a direct current (DC) motor is used for the cutter motor 403. A cutter sensor 407 realizes a high-speed move and stop control by detecting positions of the movable blade 402, and causing it to be stopped by a short brake which causes both terminals of the DC motor to be directly coupled in response to a detecting timing. The cutter sensor 407 is arranged so that the movable blade 402 is stopped usually at the top dead center, and when further one wants to cause it to be stopped at the bottom dead center, this can be coped with by adding a similar sensor.

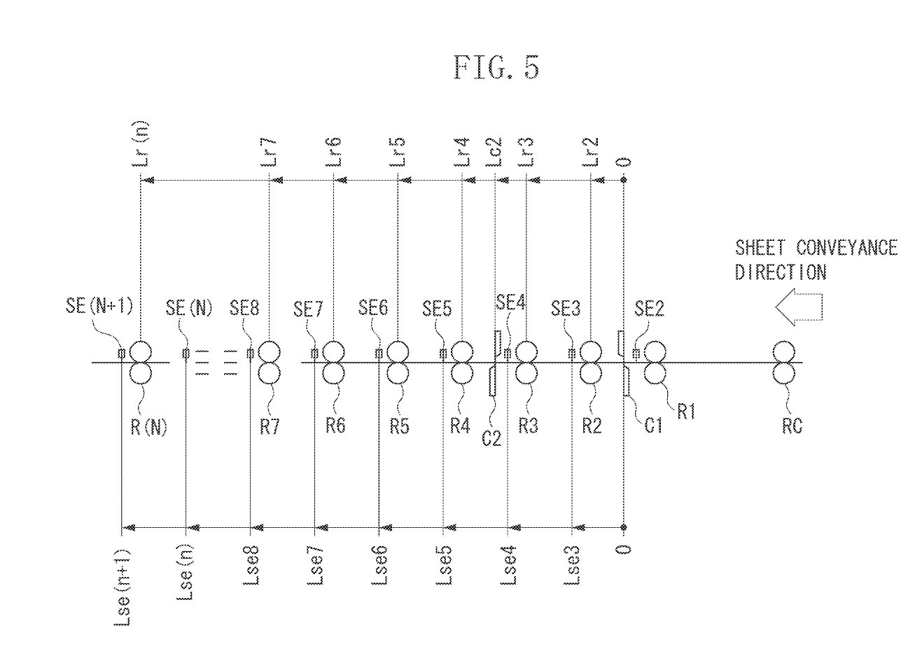

FIG. 5 is a schematic view illustrating a configuration of the sheet cutting and conveying unit including the sheet trailing edge cutting and separation mechanism according to the first exemplary embodiment of the present invention. In FIG. 5, the sheet is conveyed from right to left, as indicated by a block arrow. The cutting unit includes two sets of a first cutter C1 and a second cutter C2, each is a slide type cutter composed of a pair of fixed blade and movable blade.

The conveyance unit of the sheets includes conveyance roller pairs including drive rollers that rotate by obtaining power from motors (not illustrated) and driven rollers that rotate freely by being press-contacted by the drive rollers each aligned along a conveying direction. Arrangement spacing of respective conveyance roller pairs are designed to be a little shorter than lengths of a product of which conveyance can be coped with by the apparatus. The sheet shorter than the arrangement spacing of the conveyance roller pairs cannot be conveyed, which accordingly becomes out of specification. As a conveyance assist unit, a guide member of the sheet is arranged between the rollers, but it is unnecessary for descriptions of the present invention, and is not illustrated in FIG. 5.

A most-upstream conveyance roller pair RC feeds the continuous sheet at a constant speed into the first cutter C1, and will not change the speed in connection with cutting operation of the first cutter C1, and may be configured not to be included in the sheet cutting and conveying unit, but to be included in the inspection unit as the previous step. A conveyance roller pair R1 is arranged on the upstream side with respect to the first cutter C1. Between the first cutter C1 and the second cutter C2 are arranged conveyance roller pairs R2 and R3. On the downstream of the second cutter C2 are arranged conveyance roller pairs R4, R5, R6, and R7. On the upstream side of R2, R3, R4, R5, R6, and R7 are arranged edge sensors SE2, SE3, SE4, SE5, SE6, and SE7 that can detect edges of the leading edge or the trailing edge of the sheet to be conveyed. In a case where a length of the sheet after being cut becomes large, an edge sensor SE (N) and a conveyance roller pair R(N) are added on the downstream side.

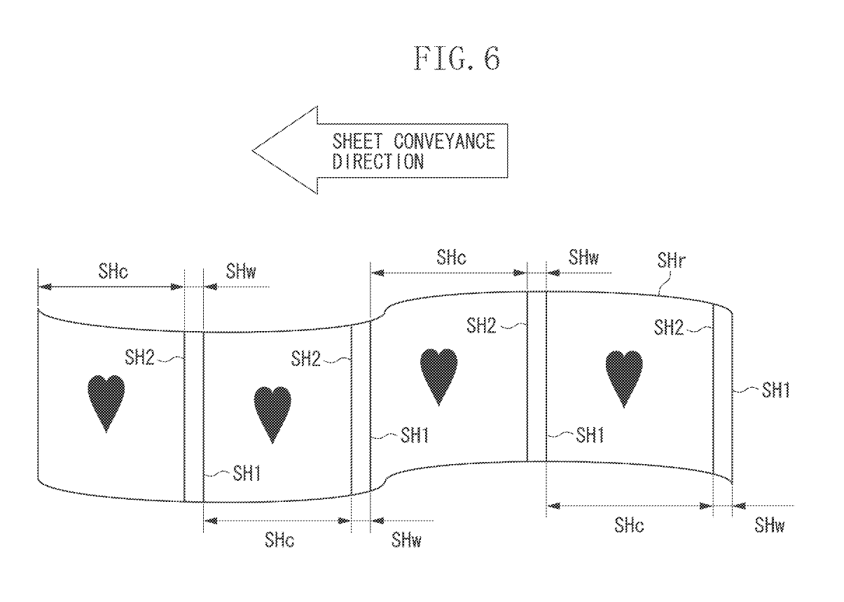

FIG. 6 illustrates an image formation example on the continuous sheet before cutting to be conveyed to the sheet cutting and conveying mechanism in FIG. 5. Portions of the products SHc after cutting and unwanted portions SHw are alternately and continuously printed on a continuous sheet SHr before cutting, and they are separated by the first cutter C1 and the second cutter C2. The unwanted portions SHw become necessary for obtaining the cut products SHc, and are used for mark arrangements for precise detections of cutting positions and run-off printing in a case of obtaining borderless image products without margins, and maintenance of print heads and the like. The length of the unwanted portions SHw changes to various sizes from several millimeters to a length as long as the product. A position to be cut by the first cutter C1 is SH1, a position to be cut by the second cutter C2 is SH2, and the unwanted portion SHw is divided at the second cutter C2 portion.

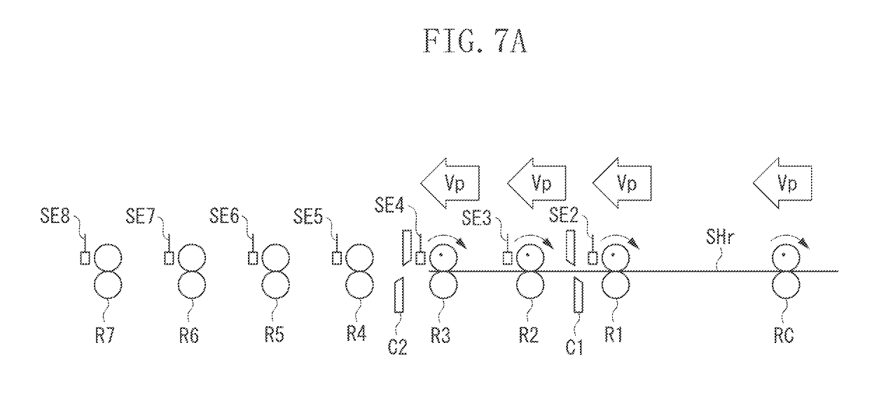

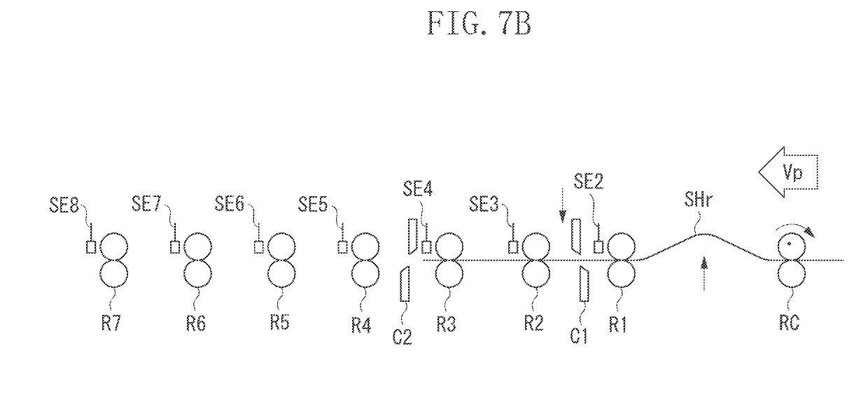

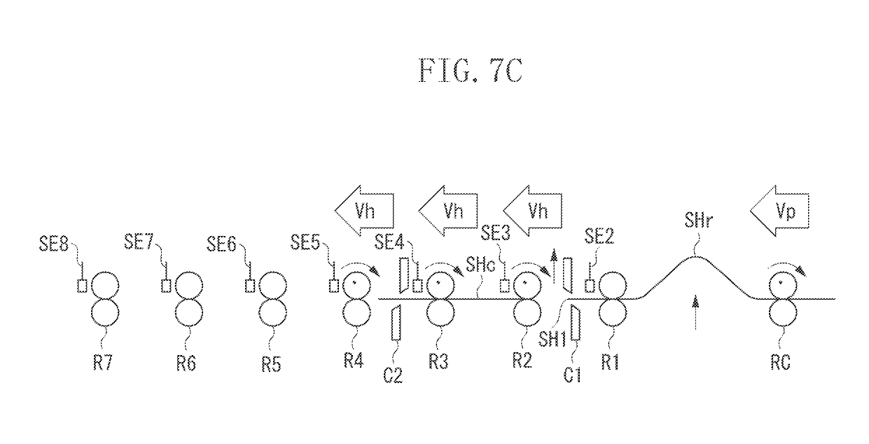

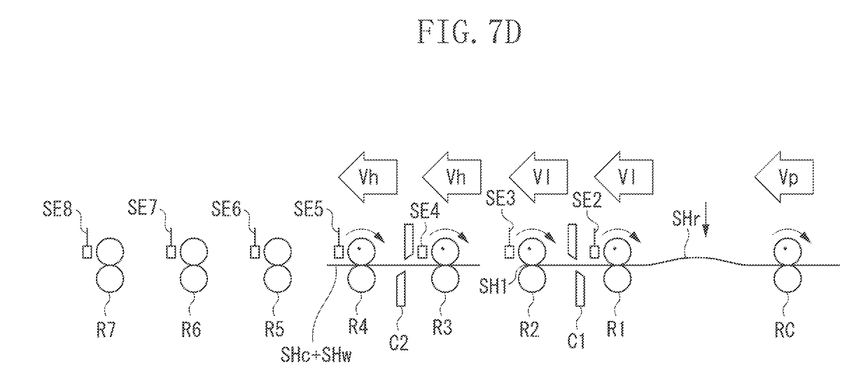

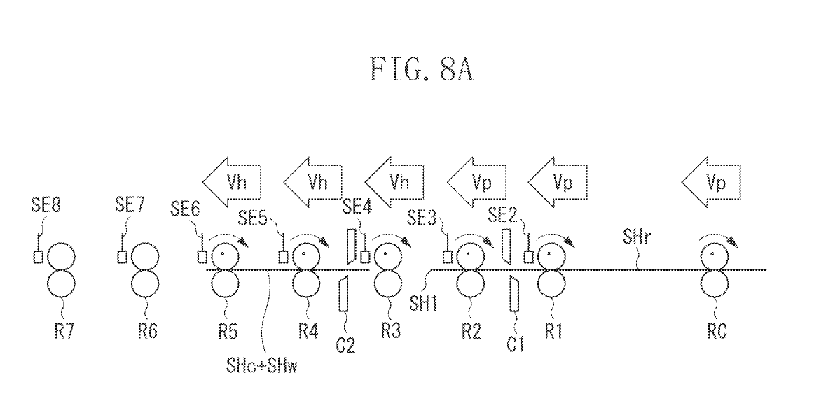

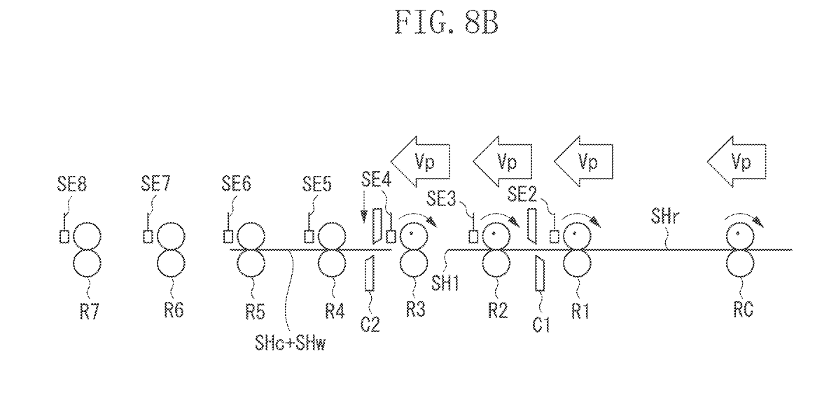

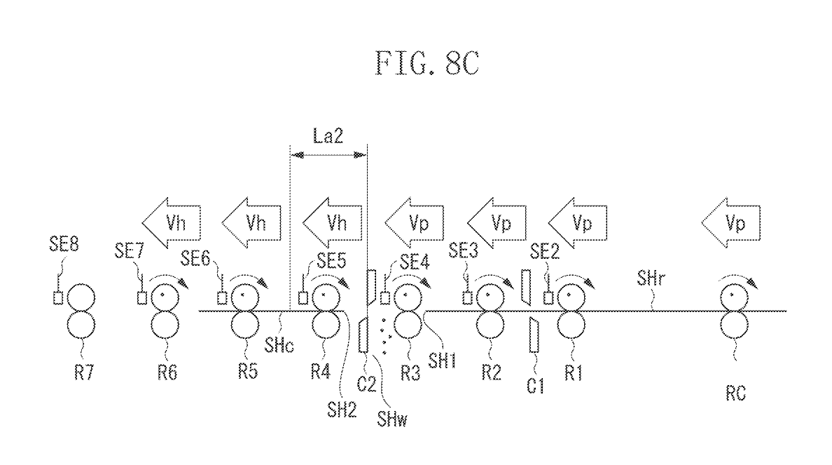

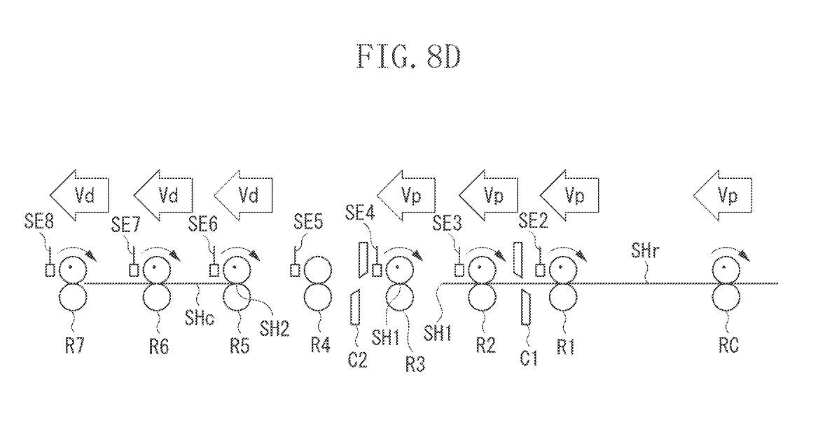

FIGS. 7A to 7D, and FIGS. 8A to 8D are schematic views illustrating how the sheet is cut and conveyed in a step-by-step manner by the sheet cutting and conveying mechanism in FIG. 5.

FIG. 7A illustrates a process until the printed sheet reaches a cutting position. The continuous sheet SHr before cutting which is continuously conveyed at a conveyance speed Vp from upstream passes through the conveyance roller pairs R1, R2, and R3, which operate at the same conveying speed, arranged fore and aft of the first cutter C1 and reaches the cutting position. To determine the cutting position, for example, the leading edge of the sheet after passing through the conveyance roller pair R1 is detected by the edge sensor SE2, and a length after passing between the blades of the cutter, namely, a cutting position can be determined by a conveyance amount of the conveyance roller pair R1 after being detected. Further, it is also possible to determine the cutting position by detecting a formed image by using an image sensor apart from the edge sensor SE2.

FIG. 7B illustrates a state when the first cutter C1 cuts the sheet. The roller pairs R1, R2, and R3, which sandwich the continuous sheet, cause the SH1 to be positioned at the cutting position of the cutter C1 and stop there, and hold the sheet during an operation of the cutter C1. Since the continuous sheet SHr before cutting on which images have been printed is conveyed from the upstream, even while the sheet is being stopped at the first cutter C1 portion, the continuous sheet SHr before cutting is reserved in a loop shape on the upstream of the conveyance roller pair R1.

FIG. 7C illustrates a state immediately after the cutting by the first cutter C1 is completed. After completion of the cutting, to release the loop-like reservation and to prevent an overlap of the continuous sheet SHr before cutting and the product SHc, it is necessary to convey the products SHc side after cutting at a speed Vh faster than the continuous sheet conveyance speed Vp. While the conveyance roller pair R1 on the continuous sheet side remains stopped, the conveyance roller pairs R2, R3, and R4 are driven at the conveying speed Vh to start conveying the products SHc attached with the unwanted portions SHw after cutting up to the cutting position by the second cutter C2.

FIG. 7D illustrates a state after further elapse of very short time, immediately after conveying at the Vh speed the cut sheet SHc attached with the unwanted portions SHw on the trailing edge side. To release the loop reserved during the time that the conveyance roller pair R1 had been stopped, the continuous sheet side is conveyed from the cutter by a predetermined length to release the loop on a condition that the product and the leading edge of the continuous sheet do not overlap each other and at a speed of V1 that meets V1>Vp, in corporation with the conveyance roller pairs R1 and R2.

FIG. 8A illustrates a state in which the cut sheet SHc attached with the unwanted portion SHw already cut by the first cutter C1 has reached the cutting position of the second cutter C2. The leading edge of the continuous sheet to be conveyed at the conveyance speed Vh after being cut by the cutter C1 is detected by the edge sensor SE4. A length after passing between the blades of the second cutter C2, namely, a cutting position can be determined based on a rotation amount of the conveyance roller pair R4 after being detected. Further, it is also possible, similarly to the first cutter C1 portion, to determine a cutting position by detecting a formed image using the image sensor aside from the edge sensor SE4.

FIG. 8B illustrates a state when cutting by the second cutter C2. The product SHc attached with the unwanted portion SHw on the trailing edge side which has been already cut by the first cutter C1 is stopped while being sandwiched by the roller pairs R4 and R5 downstream of the second cutter C2, and the sheet is held during operation of the second cutter C2. The unwanted portion SHw on the upstream side of the second cutter C2 is cut off concurrently with the cutting, and is discarded from within the sheet conveyance path by free fall due to gravity and a unit utilizing air stream as an assist.

FIG. 8C illustrates a state immediately after the cutting by the second cutter C2 is completed. The product SHc after completion of the cutting by the second cutter C2 is conveyed by a predetermined length LA2 at a speed Vh faster than the continuous sheet conveying speed Vp by the conveyance roller pairs R4, R5, and R6, to prevent an overlap with a new product SHc conveyed at a high escaping speed Vh from the upstream.

FIG. 8D illustrates a state continued from FIG. 8C. The product SHc is conveyed by the conveyance roller pairs R5 and R6 at a speed Vd required by the drying unit 8, and the conveyance roller pair R4, from which the product SHc is separated, returns to the state in FIG. 7A and repeats the conveyance.

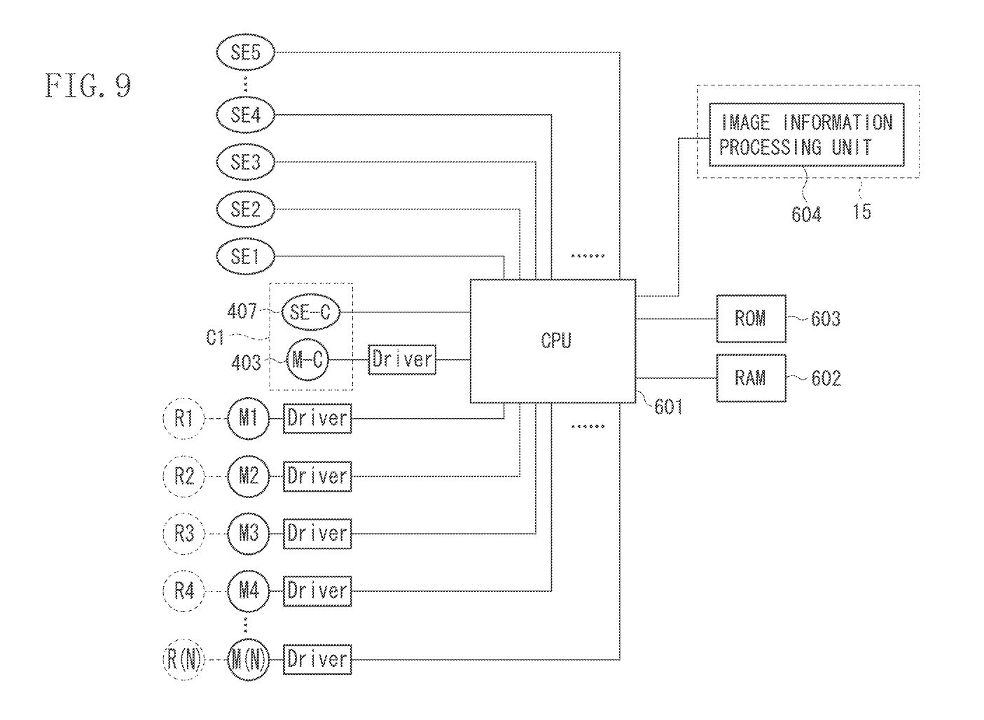

FIG. 9 is a block diagram illustrating a control configuration of the recording medium cutting apparatus according to the present invention. Outputs of the edge sensors SE2 and SE3 and the like are input into a central processing unit (CPU) 601. The CPU 601 drives and controls respective motors M1, M2, and M3 that drive the conveyance roller pairs R1, R2, and R3 via respective drivers. Further, other motors, and sensors within the unit, chief among them being the cutter motor 403, the cutter sensor 407 included in a configuration of the first cutter C1 are also connected to the CPU 601, and their operations are controlled.

A control program which the CPU 601 should perform is stored in the read only memory (ROM) 603, and the data used when the CPU 601 performs control is stored in the random access memory (RAM) 602. Among the control data, data relating to lengths and cutting positions of sheets as products after cutting is input from an external device 16 to a main body controller 15, and is processed by an image information processing unit 604 within the main body controller 15 and is input into the CPU 601.

The recording medium cutting apparatus according to the present invention relates to the periphery of the second cutter C2 which separates the unwanted portions from the products.

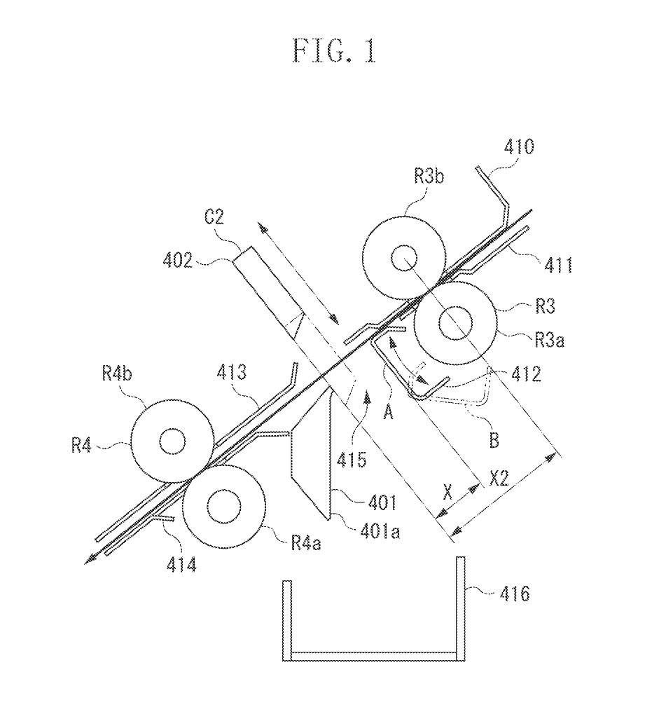

FIG. 1 illustrates a schematic sectional view of the periphery of the second cutter C2 serving as the recording medium cutting apparatus according to the present invention. In FIG. 1, a shape of the second cutter C2 serving as the cutting unit is represented more in detail than FIG. 4.

The second cutter C2 is composed of a pair of blades consisting of a fixed blade 401 as a first blade, and a movable blade 402 as a second blade arranged on the upstream upside in the conveying direction of the fixed blade 401. The movable blade 402, one of the pair of blades moves across the conveyance path in a downward direction as a cutting direction, thereby cutting the recording medium.

The conveyance path of the sheet is inclined downwardly in the conveying direction, and the sheet is conveyed from top-right in FIG. 1 toward bottom-left in FIG. 1. On the upstream of the second cutter C2 is arranged a conveyance roller pair R3 as a conveyance unit including rollers R3a and R3b. On the downstream side of the second cutter C2 is adjacently arranged a conveyance roller pair R4 consisting of rollers R4a and R4b. Between the roller pair and the cutter, up and down on the upstream and downstream side in the conveying direction, paper guides 410, 411,412, 413, and 414 each are arranged to avoid an operation zone of the second cutter C2.

A discharge port 415 is used to discharge a portion of the recording medium cut off by the second cutter C2 in midway of the conveyance path. A movable paper guide 412 on the upstream down side is movable to two positions A and B by a driving source (not illustrated), and usually is stopped at the position A. When the movable paper guide 412 moves to the B position, the discharge port 415 is enlarged in the conveying direction.

The cutting and separation operation varies depending on a length of the unwanted portion SHw as a trailing edge side portion of the recording medium. The shortest first unwanted portion length is equivalent to a length shorter than a distance X along the conveying direction from a leading edge of the fixed blade 401 to the leading edge of the movable paper guide 412.

The next longer unwanted portion length is equivalent to a second unwanted portion length. A portion of the unwanted portion SHw can be held by the conveyance unit on the upstream side. The unwanted portion SHw is the portion of the trailing edge side of the recording medium when it is cut by the cutter portion C2. An unwanted portion length separable at this time only needs to be longer than a distance X2 along the conveying direction from the tip of the fixed blade 401 to a nip portion of the conveyance roller pair R3, and it is necessary to make adjustment during image formation as necessary.

Furthermore, the second length is divided into a length non-conveyable by the conveyance unit and a third unwanted portion length conveyable by the conveyance unit. The third unwanted portion length conveyable by the conveyance unit must be longer than a maximum distance between adjacent conveyance roller pairs within the apparatus.

An accommodating unit 416 receives and accommodates the unwanted portions SHw which has been cut and fallen.

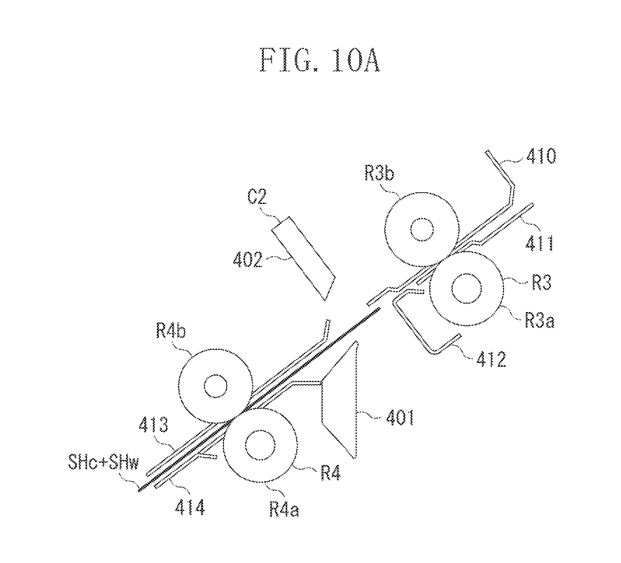

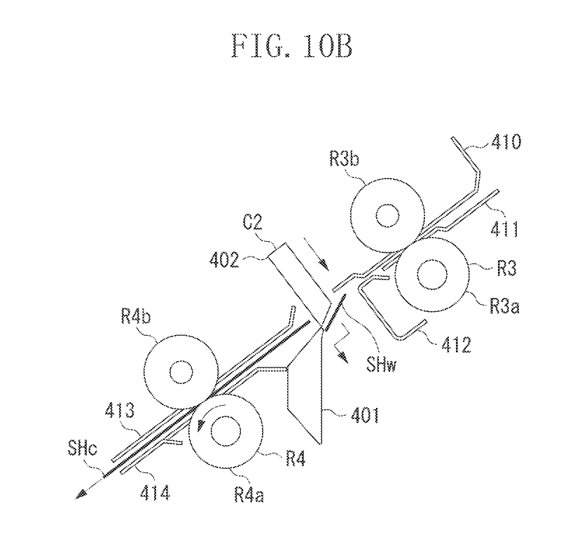

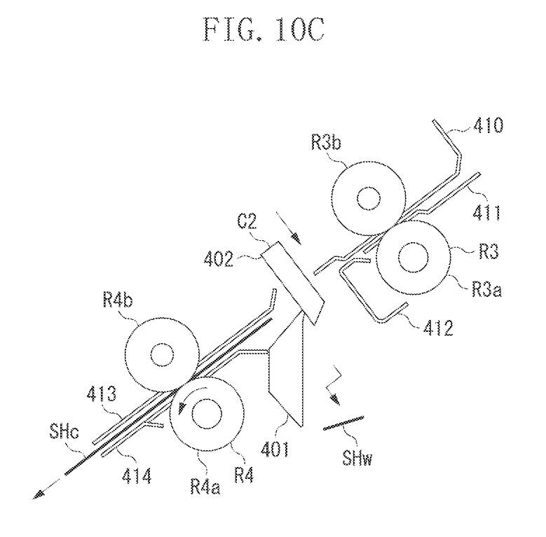

FIGS. 10A, 10B, and 10C are schematic views illustrating in a step-by-step manner how the sheet is cut and conveyed by the sheet trailing edge cutting and separation mechanism according to the present invention, in a case where the unwanted portion SHw is the first length shorter than the distance X. The movable paper guide 412 remains stopped at the position A, and a length of the first unwanted portion SHw separable at this time is a length shorter than the distance X along the conveying direction from fixed blade 401 to the tip of the movable paper guide 412.

FIG. 10A illustrates a state in which the printed sheet is conveyed to reach the cutting position. The product SHc attached with the unwanted portion SHw after cutting becomes a state in which the unwanted portion SHw is left backward from the second cutter C2 and is stopped and held by conveyance roller pair R4.

FIG. 10B illustrates a state in which the sheet is being cut. The sheet is cut at the cutting position by a descending action of the movable blade 402. The movable blade 402 serving as the discharge unit comes into contact with the unwanted portion SHw which is a portion of the recording medium cut from an opposite side of the discharge port 415 (FIG. 1), and pushes it out downwardly. The unwanted portion SHw is passed through the discharge port 415 by the movable blade 402 and is pushed to the outside of the conveyance path. Even if the movable blade 402 has not completed one-cycle operation, conveyance of the product SHc to the next step may be started by the conveyance roller pair R4, if it is in the timing when the unwanted portion SHw has been completely cut.

FIG. 10C illustrates a state in which the unwanted portion SHw is being separated. The unwanted portion SHw pushed out from the discharge port as a clearance between the fixed blade 401 and the paper guide 412 falls by gravity and is discarded from the conveyance path.

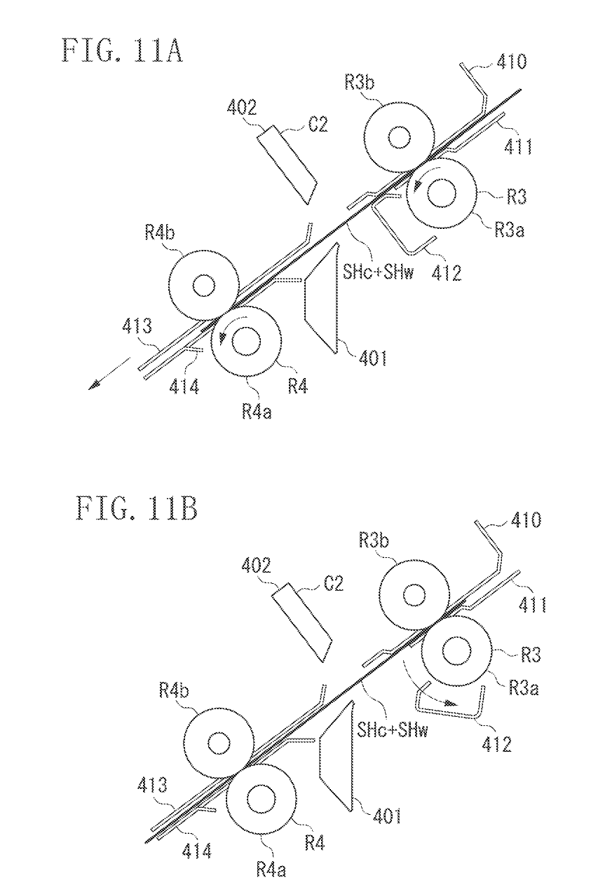

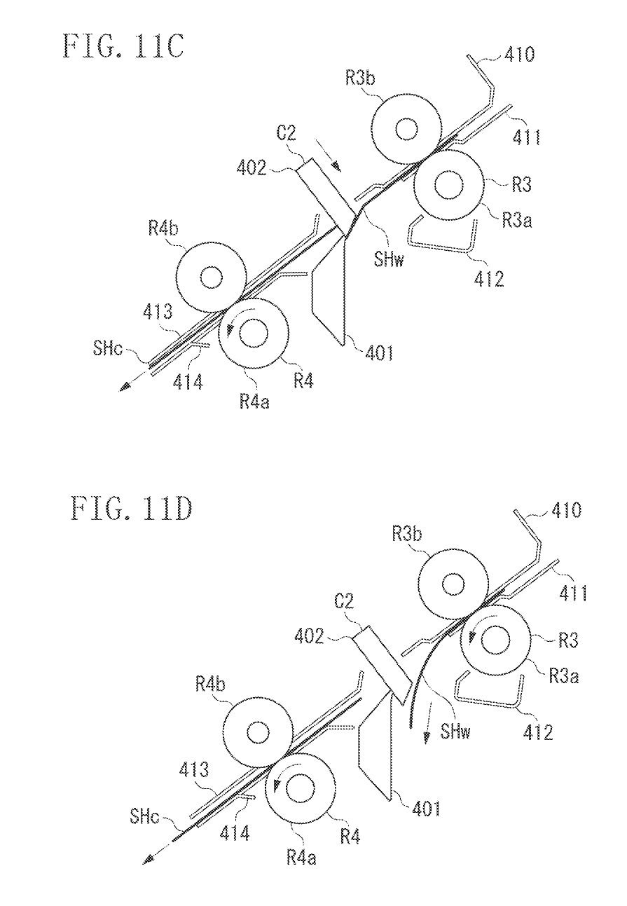

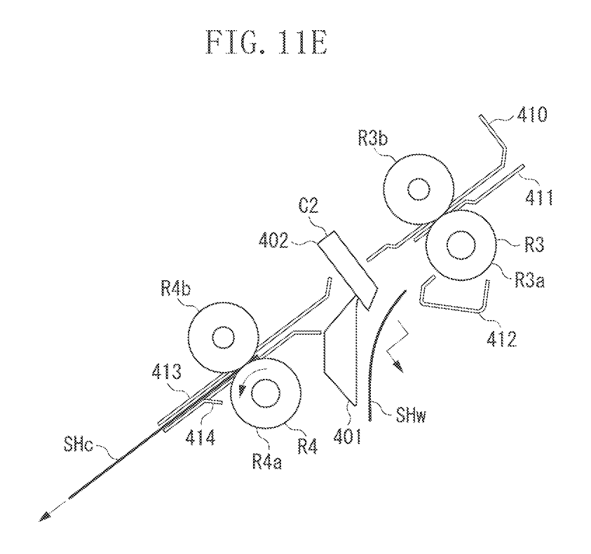

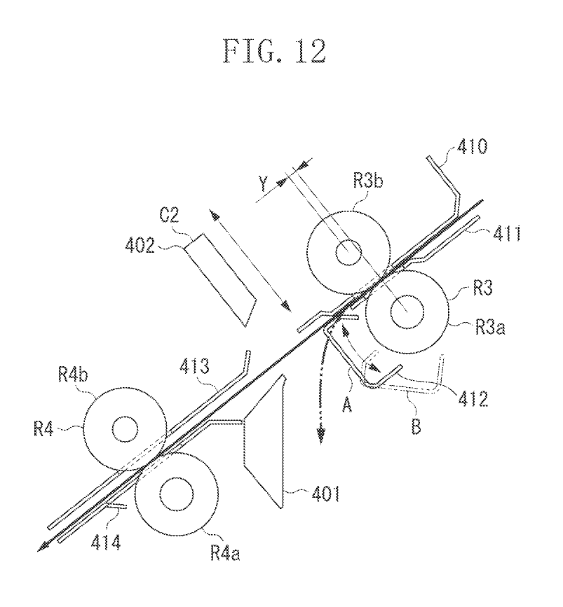

FIGS. 11A to 11E are schematic views illustrating in a step-by-step manner how the sheet is cut and conveyed by the sheet trailing edge cutting and separation mechanism according to the present invention, in a case of the second length where the unwanted portion SHw is long.

FIG. 11A illustrates a state in which the sheet is conveyed and the leading edge thereof is held by the conveyance roller pair R4 on the downstream side of the second cutter C2. Until the leading edge thereof reaches the conveyance roller pair R4, the movable paper guide 412 on the upstream downside is held at the position A, and the product SHc attached with the unwanted portion SHw is further conveyed thereafter until it reaches the cutting position.

FIG. 11B illustrates a state in which the movable paper guide 412 on the upstream downside of the second cutter C2 moves to the position B, and the product SHc attached with the unwanted portion SHw is conveyed to reach the cutting position and is sandwiched by the conveyance roller pair R4. There is no problem even when the movable paper guide 412 on the upstream downside moves immediately after the state in FIG. 11A in which the movable paper guide 412 has assisted conveyance of the leading edge portion.

FIG. 11C illustrates a state in which the sheet is being cut. The product SHc attached with the unwanted portion SHw is cut at the cutting position by the descending action of the movable blade 402, and the end portion of the unwanted portion SHw is pushed out downwardly by the movable blade 402.

FIG. 11D illustrates a state when movement in the cutting direction of the movable blade 401 is completed. In this case, the movable blade 402 reaches a bottom dead center of reciprocating movement and is in a state in which the cutting is completed. The leading edge of the unwanted portion SHw is pushed downwardly by the movable blade 402 serving as the discharge unit, and is pushed to the outside of the conveyance path via the discharge port 415. In this state, the leading edge of the unwanted portion SHw moves to a position at which it is easy to receive a guide by a surface on the upstream side of the fixed blade 401. At this time point, the unwanted portion SHw which is the downstream side portion of the recording medium cut off by starting a drive of the conveyance roller pair R3 is conveyed to the downstream side. At this time point, the movable blade 402 is temporarily stopped.

The unwanted portion SHw to be conveyed to the downstream side is fed out downwardly while being guided by a vertical surface 401a constituting a guide unit by the surface on the upstream side of the fixed blade 401. To guide the unwanted portion SHw to the outside of the conveyance path, it is useful that the conveying direction of the conveyance roller pair R3, and the surface 401a on the upstream side of the fixed blade 401 serving as the guide surface for guiding the recording medium form a blunt angle. Further, at the same time the conveyance roller pair R4 may be driven to start conveying the product SHc to the next step. Since the conveying direction of the conveyance roller pair R3, and the surface 401a on the upstream side of the fixed blade 401 form a blunt angle, the unwanted portion SHw is downwardly guided and falls, while travel is not obstructed by the fixed blade 401.

FIG. 11E illustrates a state in which feeding the unwanted portion SHw downwardly is completed. The unwanted portion is in a state in which the trailing edge portion thereof comes free from the conveyance roller pair R3, further comes free also from a movable zone of the movable paper guide 412 on the upstream downside, and falls on the downside and becomes separated. After that, the movable paper guide 412 on the upstream downside returns to the position A, and repeats the same cycle from the state in FIG. 11A. In this manner, the fixed blade 401 is provided with the vertical surface 401a serving as a guide surface for causing a tip of the trailing edge portion of cut off sheet to escape to the outside of the conveyance path.

In a case where the unwanted portion SHw is the second length, the unwanted portion SHw can be separated downwardly by the method as described above. However, in a case of a third length range in which the unwanted portion becomes longest, depending on capacity limitations of the accommodating unit 416, it is optional to convey the unwanted portion SHw, without operating the movable paper guide 412, after cutting similarly to the product SHc, and to separate the unwanted portion SHw by the sorter unit 11 on a most-downstream side.

In the exemplary embodiment described above, the guide surface 401a is formed by the surface on the upstream side of the fixed blade 401, but it may be configured to integrally fix a member different from the fixed blade 401 to the fixed blade 401.

FIG. 12 is a schematic sectional view illustrating the periphery of the second cutter C2 of the sheet trailing edge cutting and separation mechanism according to a second exemplary embodiment of the present invention.

The arrangement of the second cutter C2 and paper guides 410, 411,412, 413, and 414, and the conveyance roller pairs R3 and R4 is similar to that in the first exemplary embodiment. The conveyance roller pair R3 arranged on the upstream of the second cutter C2 is positioned such that the roller R3b on upside is offset by a distance Yon the downstream side in the conveying direction relative to the roller R3a on downside. More specifically, a center of rotation of the roller R3b on upside is arranged downstream by the distance Y than a center of rotation of the roller R3a on downside, and a common tangent line between the roller R3b on upside and the roller R3a on downside at a nip portion is inclined downwardly relative to the conveying direction. The sheet fed from the conveyance roller pair R3 is pushed by the movable paper guide 412 at the position A and is guided between the blade of the second cutter C2 and the movable paper guide 412. When the movable paper guide 412 moves to the position B, the sheet is actively fed downwardly, and operated similarly to the first exemplary embodiment.

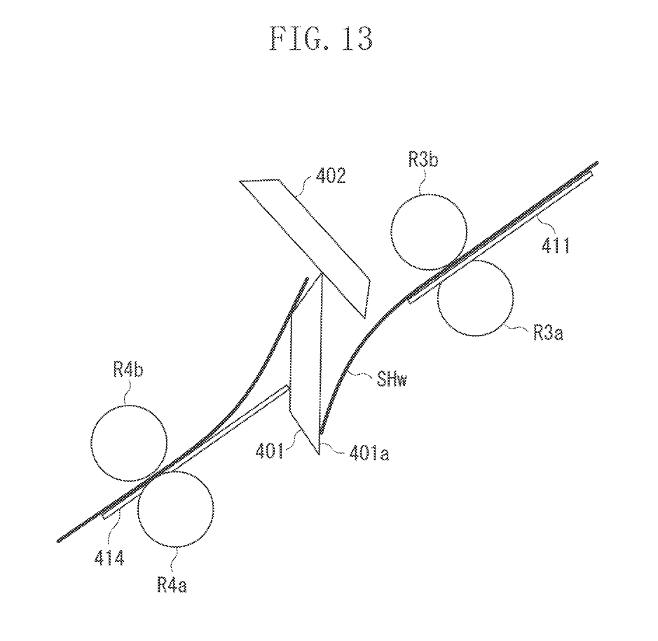

FIG. 13 illustrates a third exemplary embodiment. In the third exemplary embodiment, a blade 401 on downside is a movable blade, and a blade 402 on upside is a fixed blade. FIG. 13 illustrates a state immediately after the movable blade 401 moves upwardly to cut off the trailing edge portion SHw of the sheet, and a conveyance of the unwanted portion SHw is started by the conveyance roller pair R3. Since the paper guide 411, and the guide surface 401a formed on the upstream side of the movable blade 401 are arranged to create a blunt angle, the leading edge of the unwanted portion SHw is guided to the outside of the conveyance path by the guide surface 401a.

In the above-described exemplary embodiment, the portion of the trailing edge side of the cut off recording medium is guided to the outside of the conveyance path, by forming a guide unit on the blade of the cutter. In a case where the portion of the leading edge side of the recording medium is cut off, the guide unit may be arranged on the downstream side of the cutter, and the portion of the leading edge side of the recording medium to be cut off may be guided toward the outside of the conveyance path by the guide unit. In this case, by guiding the portion of the leading edge side of the recording medium guide which has passed through the cutter before cutting toward the outside of the conveyance path by the guide unit, and cutting it by the cutter, the portion of the leading edge side of the recording medium is caused to fall by the guide unit. When the portion of the leading edge side has fallen, the guide unit is retracted from the conveyance path, a remainder of the recording medium is conveyed downstream through the conveyance path.

In the above-described exemplary embodiments, since the portion of the recording medium which has been cut off to obtain completed product can be guided toward the outside of the conveyance path without depending on only gravity, freedom of apparatus layouts, and enhancement of processing speeds are achieved. Even if a length of the portion to be cut off varies, cutting processing can be performed at a high speed.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-028822 filed Feb. 14, 2011, which is hereby incorporated by reference herein in its entirety.

What is claimed is:

1. A recording medium cutting apparatus comprising:
a conveyance unit configured to convey a recording medium;
a conveyance path on which the recording medium to be conveyed by the conveyance unit passes;
a cutting unit configured to cut the recording medium;
a discharge port configured to be provided on the midway of the conveyance path and discharge a portion cut off from the recording medium by the cutting unit from the conveyance path; and
a discharge unit configured, when the recording medium is cut, to come into contact with the recording medium from an opposite side to the discharge port, to cause a portion to be cut off from the recording medium to be positioned toward an outside of a conveyance path from the discharge port.

2. The recording medium cutting apparatus according to claim 1, wherein the discharge unit is configured, when the portion of the leading edge side of the recording medium is cut off, to guide the leading edge of the recording medium toward the outside of the conveyance path before cutting.

3. The recording medium cutting apparatus according to claim 1, wherein the discharge unit is configured, when the portion of trailing edge side of the recording medium is cut off, to push out the cut off portion of trailing edge side toward the outside of the conveyance path.

4. The recording medium cutting apparatus according to claim 1, wherein the discharge unit is configured, when the portion of trailing edge side of the recording medium is cut off, to guide the portion of trailing edge side which has been cut off and conveyed by the conveyance unit, to the outside of the conveyance path.

5. The recording medium cutting apparatus according to claim 1, wherein the cutting unit is configured to include a first blade and a second blade, wherein at least one of the blade is configured to also serve as the discharge unit.

6. A recording medium cutting apparatus comprising:
a conveyance unit configured to convey a recording medium to travel on a conveyance path;
a cutting unit configured to be arranged on a downstream side in a conveyance direction of the conveyance unit and include a first blade and a second blade which cut the recording medium; and
a guide configured to guide the recording medium from the conveyance unit to the cutting unit,
wherein a clearance is configured to be provided between the cutting unit and the guide so that a portion of a trailing edge side of the recording medium which has been cut off falls, when a portion of the trailing edge side of the recording medium to be cut off by the cutting unit is a first length which is not held by the conveyance unit during cutting, and
wherein the conveyance unit is configured to convey the portion of the trailing edge side after cutting, and a guide unit formed on the first blade is configured to guide a tip of a portion of the trailing edge side to be conveyed toward the outside of the conveyance path, when the portion of trailing edge side of the recording medium to be cut off by the cutting unit is a second length which is held by the conveyance unit during cutting.

7. The recording medium cutting apparatus according to claim 6, wherein the guide unit is configured to include a guide surface formed on the first blade, and the guide surface and the conveyance path form a blunt angle.

8. The recording medium cutting apparatus according to claim 6, wherein the conveyance path is configured to include a downward inclination in a traveling direction of the recording medium.

9. The recording medium cutting apparatus according to claim 6, wherein the guide is configured to be movable to enlarge the clearance.

10. The recording medium cutting apparatus according to claim 7, wherein the conveyance unit is configured to convey the recording medium to press it against the guide surface.

11. The recording medium cutting apparatus according to claim 6, wherein the cutting unit is configured to cut the recording medium by the second blade that moves across the conveyance path,
and wherein the conveyance unit is configured, when the portion of the trailing edge side of the recording medium to be cut has a second length, to start conveyance of the cut trailing edge side portion of the recording medium during a period until the second blade completes movement in a cutting direction, after the cutting is completed.

12. The recording medium cutting apparatus according to claim 11, wherein the second blade is configured to temporarily stop at a position at which movement in a cutting direction is completed.
